(19) United States
(12) Patent Application Publication
(10) Pub. No.: US 2019/0389487 A1
(43) Pub. Date: Dec. 26, 2019

(54) TAILGATING ALERT SYSTEM IN VEHICLES

(71) Applicant: Byton North America Corporation, Santa Clara, CA (US)

(72) Inventors: Srini Gowda, Solihull (GB); Becky Soltanian, Mountain View, CA (US)

(21) Appl. No.: 16/015,973

(22) Filed: Jun. 22, 2018

(51) Int. Cl. B60W 50/14; B60Q 9/00; B60Q 1/50; B60W 30/09; G01S 13/58; G01S 13/93

(52) U.S. Cl. CPC B60W 50/14; B60Q 9/00; B60Q 1/503; B60W 30/09; B60W 2550/20; G01S 13/931; B60W 2520/10; B60W 2550/308; G01S 13/583

(57) ABSTRACT

Systems and methods describe detecting, from a first vehicle, a second vehicle to the rear of the first vehicle and determining a speed of the second vehicle. Systems and method continue to determine, based on the speed of the second vehicle, that there is an unsafe distance between the first vehicle and the second vehicle and present, on a user interface of the first vehicle, a warning indicating that there is an unsafe distance between the first vehicle and the second vehicle.

### TECHNICAL FIELD

The disclosed embodiments relate generally to detection and alerting to unsafe driving conditions.

### BACKGROUND

Modern vehicles include a variety of sensors and intelligence systems to improve the safety of driving. For example, airbags, crash preparation systems, or the like can improve the outcome for vehicle passengers in the case of an accident. Furthermore, modern vehicles can also include intelligence systems that improve safety of drivers. For example, modern vehicles can include advanced driver assistance systems (ADAS) that provide driving assistance such as lane assist, adaptive cruise control, auto-pilot, or the like.

However, these systems lack adequate systems to improve safety in the case of tailgating. Following too closely behind a vehicle can put the lead vehicle and the vehicles that follow in danger. When driving, a safe distance is generally considered to be around 3 seconds. If following closer than three seconds behind the car in front, there is potentially inadequate time to react and brake in the case the lead car comes to an abrupt stop.

### SUMMARY

The disclosure describes embodiments of an apparatus and method for providing a tailgating alert. Systems and methods describe detecting, from a first vehicle, a second vehicle to the rear of the first vehicle and determining a speed of the second vehicle. Systems and method continue to determine, based on the speed of the second vehicle, that there is an unsafe distance between the first vehicle and the second vehicle and present, on a user interface of the first vehicle, a warning indicating that there is an unsafe distance between the first vehicle and the second vehicle.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic diagram of an embodiment of systems to analyze rear facing sensors within a car, which can be used in accordance with some embodiments.

FIG. 2. is an example interface generated by embodiment of systems to analyze rear facing sensors within a car, which can be used in accordance with some embodiments.

FIGS. 3A and 3B are example interfaces generated by systems to analyze rear facing sensors within a car, which can be used in accordance with some embodiments.

FIG. 4 is a flow diagram of an embodiment of systems to analyze rear facing sensors within a car, which can be used in accordance with some embodiments.

FIG. 5 is a flow diagram of an embodiment of systems to analyze rear facing sensors within a car, which can be used in accordance with some embodiments.

### DETAILED DESCRIPTION

Methods and systems disclosed herein provide a warning in the case tailgating is detected. For some embodiments, vehicles described herein may also include automatic driving features that react to tailgating in a manner to improve safety of the passengers.

For some embodiments, a vehicle may have one or more types of sensors that provide information about the vehicles and surrounding areas. For example, a vehicle may include sonar, radar, cameras, other imaging devices, or additional sensors that scan an area surrounding the car. A tailgating alert system can use data from the sensors to determine whether a trailing vehicle is tailgating. For example, for some embodiments, the vehicle includes a rear radar system. The radar can detect objects in a field of view to the rear of the vehicle. For example, the radar may have a range of 100-200 feet. When the radar detects an object to the rear of the vehicle, it can determine a distance at which the trailing vehicle is following. Depending on the speed of the vehicle and the distance between the vehicles, the tailgating alert system can determine if the trailing car is following at a safe distance.

For some embodiments, in response to determining that the vehicle is not following at a safe distance, the tailgating alert system can provide an alert to the driver. For example, the vehicle may include a display unit on the front dash. The display unit can receive an indication from the tailgating alert system of the potentially dangerous situation and provide a warning to the driver that a vehicle is not following at a safe distance. The alert can also include recommendations to change lanes or speed up. For some embodiments, the vehicle also includes a rear display on a back panel. The rear display can also be used to provide a warning to the trailing car that it is too close for safe operation. The rear display can include various LEDs or a display panel that indicates to the trailing car that it is following too close.

For some embodiments, the vehicle can also operate with autonomous driving capabilities. For example, the vehicle may automatically follow in a lane or maintain a particular speed. The vehicle can then use an output of the tailgating alert system to determine how to operate safely. For example, an autonomous driving intelligence system can determine that if a car is too close, that it should increase speed to improve the distance between the vehicles. For some embodiment, the autonomous driving intelligence system can also change lanes to allow the trailing vehicle to pass.

For some embodiments, each of the vehicles may be connected to a network. For example, the vehicles may be connected to a wireless network such as 3G, 4G, 5G, or other technical standard. In that case the cars may be able to connect and provide information remotely between the vehicles. The lead vehicle can therefore provide a signal to the following vehicle that it is not following at a safe distance. The following vehicle can then provide notification to a driver that it is too close. For some embodiments, a rear vehicle driving autonomously can slow in response to receiving the alert.

For some embodiments, to improve detection of tailgating vehicles, a combination of sensors can be used. For example, radar can be used to detect the initial presence of a vehicle at long distances. Sonar can then be used to more accurately track a vehicle as it is closer. In addition, a camera can be used in combination with radar to more accurately track the vehicle. For some embodiments, images from the camera can also be used to provide additional information. For example, the camera images can be analyzed to determine a type of vehicle approaching. This information can be used to estimate safe driving distances. For example, if the camera indicates that the trailing vehicle is a truck, the tailgating alert system may assume it will take longer to brake than if the trailing vehicle is a compact car.

For some embodiments, a tailgating alert system can use additional information from additional sensors to determine whether tailgating is dangerous. For example, the vehicle can include a moisture sensor (such as on the vehicles brakes). The tailgating alert system can use an indication of moisture from the sensor to determine road conditions and change calculation of safe driving distance accordingly. For some embodiments, the tailgating alert system can also use temperature sensors, light sensors, or other available sensors. For some embodiments, the vehicle can receive real-time weather information received over a wireless network. This weather information can also be used to modify the calculation of safe driving distances.

If the tailgate alert system described herein can be used on various types of vehicles, including cars, trucks, sport utility vehicles, etc. the vehicle can include electric vehicles, vehicles with internal combustion engines, hybrid vehicles and other types of vehicles.

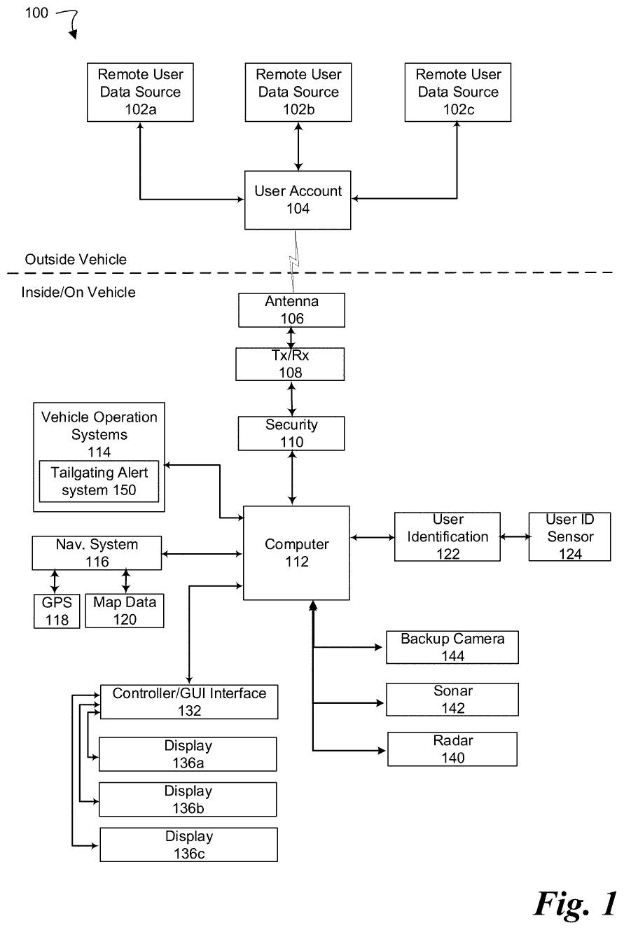

FIG. 1 illustrates an embodiment of vehicle systems 100 that can be used with a vehicle. The system 100 can include a tailgating alert system 150 operated to improve safety of vehicle operations. Vehicle systems 100 include elements outside the vehicle as well as elements inside or on the vehicle. Outside the vehicle, a user account 104 can be coupled to one or more remote user data sources 102a-102c to exchange data with the remote user data sources. User account 104 can receive data from, transmit data to, and process data exchanged with remote user data sources. User account 104 can, for example, be an account established on servers set up by a vehicle manufacturer. Remote user data sources 102a-102c can include user accounts established on remoter servers such as a user's contacts, calendar, health-related accounts, and social media accounts. For some embodiments, user account 104 can be omitted and its functions of assembling the events and their datasets can instead be performed by computer 112. In such cases, transceiver 108 can communicate directly with remote user data sources 102a-102c through antenna 106, rather than communicating with the remote user data sources through user account 104. For some embodiments, user account 104 can be used to retrieve data from remote data sources 102a-102c. For example, the user account 104 can access weather, traffic data, navigation data, or other data that can be used by vehicle operation systems 114, computer 112, or the like to improve vehicle operations. For some embodiments, the data retrieved from user data sources 102a-102c can be used by the tailgating alert system 100 to determine safe driving distances in traffic.

Inside the vehicle, a computer 112 is communicatively coupled to various elements including to a transceiver 108 via security gateway 110; vehicle operations system 114; a navigational system 116 that includes a position sensor or GPS 118 as well as a database including map data 120; a user identification system 122 coupled to one or more user ID sensors 124; a local user data storage 126 and a second transceiver 130 through which computer 112 can exchange data with a local user data source 128. A controller/graphic user interface (GUI) interface 132 is communicatively coupled to computer 112, and one or more displays 136a-136c are coupled to controller/GUI interface 132. The computer 122 is also connected to one or more of an array of sensors, such as, radar 140, sonar 142, and backup camera 144. For some embodiments, the computer 112 may be connected to additional sensors, such as temperature sensors, moisture sensors, or the like.

Computer 112 is the hub of vehicle systems 100. In the illustrated embodiment computer 112 is a programmable general-purpose computer that includes at least memory, one or more microprocessors, and storage. Other embodiments, however, can include one or more other types of computers, such as application specific integrated circuits (ASIC). Although represented as a single computer in the illustrated embodiment, for other embodiments computer 112 can include multiple processors or, can comprise multiple separate computers that can communicate and coordinate with one other. For the illustrated embodiment the elements communicatively coupled to computer 112 are represented as components separate from the computer, but for other embodiments one or more of these other components can be implemented in software and run on the computer 112. That is to say, one or more of the elements communicatively coupled to computer 112 can actually be processes running on computer 112. For example, vehicle operation systems 114 can operate as processes executed by computer 112.

Transceiver 108 is communicatively coupled via security gateway 110 to computer 112. Transceiver 108 is also coupled to antenna 106 to allow it to wirelessly exchange data with user account 104, for instance via Wi-Fi, cellular, or satellite communication. Security gateway 110 is communicatively coupled in the link between transceiver 108 and computer 112 to avoid downloading viruses, malicious code, or other data that could damage system 100 or, in particular, that could adversely influence vehicle operations systems 114 and thus compromise vehicle safety. Security gateway 110 in one embodiment can be a computer running software such as anti-virus or anti-malware software

User identification system 122 is coupled to one or more user ID sensors 124, and together they are used to identify authorized users of vehicle systems 100. For some embodiment user ID sensor 124 can include one or more facial recognition cameras, but in other embodiments other types of sensors such as biometric sensors (e.g., fingerprint or retinal scan) can be used. In still other embodiments, user identification system 122 can be a username/password system in which a user enters their username and password via a keypad or other user input system. User ID sensors 124 can be positioned inside or outside the car and used to identify the driver and/or passengers in the car.

Vehicle operation systems 114 are coupled to computer 112 so that they can be controlled and/or adjusted by the driver or passengers of the car. Among other things, car systems 114 can include those that control the engine, steering, suspension, air-conditioning, interior lighting, exterior lighting, locking, and so on. For some embodiments, vehicle operation systems 114 can include a tailgating alert system 150 that generates alerts or instructions in response to detection of a tailgating vehicle. For some embodiments, the tailgating alert system 150 may be separate from the vehicle operations systems 114. For example, the tailgating alert system 150 may operate as a separate process executed by computer 112 or as part of controller/GUI interface 132.

For some embodiments, the vehicle operation systems 114 include processes to autonomously drive the vehicle. For example, vehicle operations systems 114 can include processes to stay in a lane, maintain the speed of traffic, follow navigation to a destination, or the like. For some embodiments, the vehicle operations systems 114 can completely autonomously operate the vehicle, or may have limited autonomy that requires feedback from a user.

The tailgating alert system 150 can use data gathered from one or more sensors (e.g., radar 140, sonar 142, backup camera 144, or the like) to determine whether a detected car is tailgating. For example, the tailgating alert system 150 can use radar to detect a vehicle approaching form the rear. Based on a current speed of the vehicle, the tailgating alert system 150 can determine whether the vehicle approaching from the rear is operating at a safe distance. For some embodiment, a simple determination of whether the vehicle is following at a safe distance can be calculated from the formula:

$$d = \frac{3 \times v}{3600} ,$$

where d is the distance in kilometers between the vehicles in meters and v is the velocity of the trailing vehicle in kilometers per hour. The factor of 3 represents a safe driving distance of three seconds between the vehicles. In various embodiments, other factors than 3 can be used to determine a safe driving distance based on characteristics of one or more of the vehicles. For some embodiments, additional information can be used to determine if the rear vehicle is following at a safe distance. For example, if the rear vehicle is approaching faster than the lead car is following, the tailgating alert system 150 can use the difference in velocities along with predicted braking speeds in order to determine whether the rear vehicle could stop in time to avoid a collision with the lead vehicle. In order to determine the relative speeds of the vehicles, the radar 140 may be a frequency modulated continuous wave (FMCW) radar that can provide a speed of the rear vehicle. The FMCW radar can enable the radar 140 to provide a velocity of the rear vehicle in addition to a distance. For some embodiments, the tailgating alert system 150 can also use changes to distances measured by the radar 140 to estimate velocity of the rear vehicle.

For some embodiments, the tailgating alert system 150 can use a known speed for a road, such as the speed limit, to determine a safe following distance. For some embodiments, the tailgating alert system 150 can use current velocity of the vehicle, measured velocity of the following vehicle, real-time traffic data for the road, or other additional information in addition to or instead of a speed limit for the road.

For some embodiments, the tailgating alert system 150 can use additional information to determine whether a following vehicle is at a safe distance. For example, sonar 142 can be used to augment the accuracy of distance or velocity data generated by radar 140. Thus, a combination of measurements can be used to provide increased accuracy to measurements. For some embodiments, the tailgating alert system 150 can also use a backup camera 144 (or other rear facing camera) to improve detection of following vehicles. For some embodiments, the tailgating alert system 150 can analyze image data from backup camera 144 to detect a type of vehicle that is following. For example, a machine learning system can be used that determines a type or model of vehicle based on image analysis. In some embodiments, the image data can be used to estimate a size of the trailing vehicle or use an estimated size of the vehicle to infer a type of vehicle. For example, a radar may indicate a distance at which a vehicle is trailing and an image can be analyzed to provide estimated dimensions of the vehicle. The dimensions of the vehicle can then be used to predict the type of vehicle. The type of vehicle can be used to improve determinations of safe driving distances. For example, the type vehicle can be used to scale a safe following distance. Thus, tailgating alert system 150 may use the equation

$$d = \frac{3 \times v}{3600}$$

if image analysis of the backup camera 144 indicates there is a car following, but may change a scale of the equation to

$$d = \frac{4 \times v}{3600}$$

if an SUV is detected. Additional braking profiles for different vehicles can be used to change a determination of a safe following distance.

The tailgating alert system 150 may use additional sensor or received data to change the determination of a safe driving distance. For example, the vehicle systems 100 may include temperature or moisture sensors that can provide additional data to the tailgating alert system 150. Accordingly, if the moisture level on the road is high, the tailgating alert system 150 can increase the safe driving distance because it takes longer to brake on moist surfaces. Similarly, as temperatures below freezing can cause ice to form on a road, the tailgating alert system 150 can increase safe following distances based on low temperatures. The tailgating alert system 150 can also use data received from remote user data sources 102a-102c to improve determinations of safe following distances. For example, the computer 112 can receive navigation data that the tailgating alert system 150 uses to determining safe following distances. The navigation data can include road conditions such as whether a road is gravel, incline of a hill, blind turns, bridges, or other information that can be used to change the safe driving distances for different situations. The tailgating alert system 150 can also use weather data to change the estimated safe driving distances in rain, snow, sleet, sunny, or other conditions.

Based on the determination of a safe driving distance, the tailgating alert system 150 can set a threshold at which to generate an alert. For example, the tailgating alert system 150 can use a calculated safe following distance as a threshold and use the measured distance at which a vehicle is following to set an alert. Thus, if the tailgating alert system 150 determines that a vehicle is detected on radar 140 closer than the safe driving distance, the tailgating alert system 150 can generate an alert.

For some embodiments, the alert can be provided on a user interface of the vehicle. For example, the alert can be provided on one or more of displays 136a-136c. The alert can include a warning that a following vehicle is too close for safe driving. The tailgating alert system 150 can also provide alerts with a recommendation to change driving. For example, if the tailgating alert system 150 has navigation data of the road's speed limit and the vehicle is operating under that speed limit, the tailgating alert system 150 can generate an alert recommending speeding up. If the tailgating alert system 150 detects or receives tailgating alert system 150 that there are multiple lanes, the alert can indicate a recommendation to change lanes to allow the following vehicle to pass.

For some embodiments, the vehicle includes a rear facing display (e.g., on or as part of the bumper of the vehicle) that can also display an alert. For example, if a vehicle is following too closely, the bumper can display changing LED lights, an image indicating to increase the distance, text output indicating to slow down, or another alert.

For some embodiments, the tailgating alert system 150 may automatically change the driving behavior of the vehicle. For example, tailgating alert system 150 may provide output to the vehicle operations systems 114 to avoid the unsafe driving conditions. Depending on the scenario this can include depressing an accelerator or otherwise accelerating the vehicle until there is a threshold safe distance between the vehicles. For some situations, the tailgating alert system 150 can cause the vehicle operations system 114 to merge left or right to allow the following vehicle to pass. This can be done automatically or after requesting authorization from a driver depending on the level of autonomous driving.

For some embodiments, the tailgating alert system 150 can also provide an alert to the following vehicle. For example, the following and lead vehicles may be of the same manufacturer or otherwise able to connect wirelessly. For example, the computer 112 may communicate through user account 104 to connect to the following vehicle. The following vehicle can then receive data from the computer 112 indicating that it is closer than a safe distance. Accordingly, the following vehicle may generate a display to an interface. For some embodiments, a vehicle operations system of the following vehicle may also change driving behavior to have the following vehicle pass the lead vehicle or to slow down and increase the distance between the vehicles.

Navigation system 116 is coupled to computer 112 to provide navigation capability for the car. Among other things, navigation system 116 includes a position sensor such as a global positioning system (GPS) system 118, as well as a database that includes map data 120. Navigation system 116 uses GPS 118 to determine the current position of the car and uses map data 120 to show the current position of the car on a map, as well as the map locations of future events, on at least one of displays 136a-136c (see below). As discussed above, the tailgating alert system 150 can also use the map data to determine safe driving distances and instructions to vehicle operations system 114.

Controller/graphic user interface (GUI) 132 is coupled to computer 112 and also coupled to at least one display. In the illustrated embodiment, three displays 136a-136c are coupled to controller/GUI interface 132, but in other embodiments the number of displays coupled to the interface can be different than shown. Although illustrated and referred to as separate displays, displays 136a-136c can be different parts of a single display. As further discussed below, one of or more of displays 136a-136c can be used to display a tailgate warning alert in response to determination by the tailgating alert system 150 that a vehicle is following too closely. For some embodiments, controller/GUI 132 also controls output of alerts to displays on a rear facing surface of the vehicle.

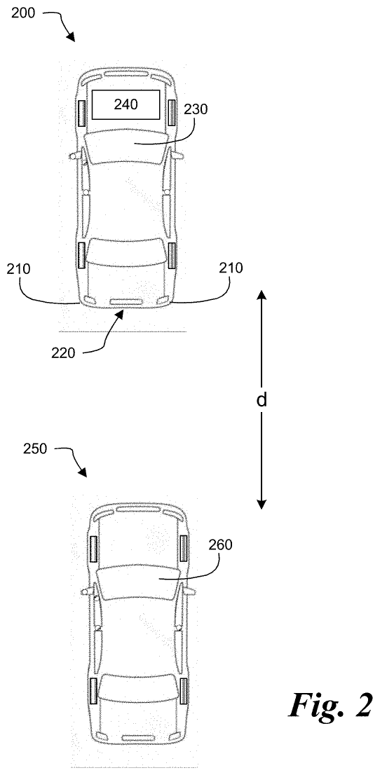

FIG. 2 illustrates and example of a first vehicle 200 followed by a second vehicle 250 at a distance d from the first vehicle 200. The first vehicle 200 may include vehicle systems 100 as described with reference to FIG. 1. In particular the first vehicle 200 may include a computer 112, vehicle operations systems 114, and a tailgating alert system 150 as described with reference to FIG. 1.

As shown in FIG. 2, the vehicle 200 includes radar 210, a backup camera 220, a display 230, and a tailgating alert system 240. For some embodiments, the vehicle 200 may include additional sensors such as sonar sensors, moisture, temperature sensors, or the like. A computing device of the vehicle 200 may receive sensor readings from radar 210 indicating the presence of the vehicle 250 to the rear. For some embodiments, the radar 210 may include an indication of the distance of the vehicle 250 to the rear. The radar 210 may also provide an indication of the velocity of the vehicle 250. For example, the radar 210 may be a FMCW radar that is capable of providing both position and velocity measurements of objects in the area.

A tailgating alert system 240 of the vehicle 200 can use the output of the radar 210 to determine the distance and position of the vehicle 250. In addition, the vehicle 200 may have navigation data indicating a speed limit of the road, data from vehicle operations systems indicating a speed of the vehicle 200, or additional data received from one or more local or remote systems to the vehicle 200. The tailgating alert system 240 can use the data from sensor 210 and additional data about the speed of either, or both, of vehicles 200 or 250 to determine whether or not the distance d provides a safe stopping distance for the following vehicle. For some embodiments, the distance d may be compared to a threshold indicating the safe stopping distance for the vehicle 250. For example, the safe stopping distance can be calculated by comparing a braking profile of an average vehicle based on an initial speed of the vehicle 250 to the distance d determined by the radar.

For some embodiments, the tailgating alert system 240 can use additional data from the backup camera 220, or another rear facing camera, to improve the determination of a safe stopping distance. For example, the tailgating alert system 240 may perform image analysis to images provided by the camera 220 in order to determine what type of vehicle 250. Based on the type of vehicle the tailgating alert system 240 can determine whether to increase or decrease a default safe distance between vehicles 200 and 250. For example, a semi-truck may take longer to come to a stop than a small car. Accordingly, the tailgating alert system 240 may increase the safe stopping distance for the semi-truck. For some embodiments, the tailgating alert system 240 may use additional data from sources such as weather reports, moisture sensor readings, temperature sensor readings, navigation data, road conditions, or other data available locally or through a network to estimate a threshold for safe stopping distances.

In response to determining that the vehicle 250 is less than a threshold away from the vehicle 200, the tailgating alert system 240 may generate an alert or warning to a driver of vehicle 200. For example, a display screen 230 may provide a user interface indicating that the following vehicle 250 is too close. For some embodiments, the warning may also indicate recommended actions such as speeding up or moving over. For some embodiments, the recommended actions may further be based on the proximity of the rear vehicle 250. For example, if vehicle 250 is closer than a safe stopping distance, but by less than a threshold margin, the tailgating alert system 240 may generate an alert to speed up. If vehicle 250 is closer than a safe stopping distance, and within a closer threshold distance or for longer than a threshold period of time, the tailgating alert system 240 may generate an alert to move over and allow the rear vehicle 250 to pass. For some embodiments, the vehicle 200 may include a rear facing screen that can provide alerts to the vehicle 250. For example, LEDs on a rear panel or rear window of the vehicle 200 can provide an alert to the vehicle 250. An alert can also be provided by a display integrated into a bumper or other rear board of vehicle 200

For some embodiments, the tailgating alert system 240 may also provide an indication of a tailgating vehicle 250 to a vehicle operation system. The vehicle operation system can use the indication of the tailgating vehicle to determine whether to change operation of the vehicle. For example, in response to a tailgating vehicle, the vehicle operation system of vehicle 200 may determine to automatically increase speed, automatically change lanes, or perform other functions. For some embodiments, the tailgating alert system 240 may provide updated operations to the vehicle operation system. For example, the tailgating alert system 240 may provide instructions to increase acceleration to a new speed, change lanes, reduce normal braking speed, or otherwise change vehicle operations to reduce the risk of the vehicle 250.

For some embodiments, vehicle 200 and 250 can be connected through a cloud based network, local network, direct wireless connection or the like. As such, the vehicle 200 may provide an indication to vehicle 250 that it is following too closely. This warning may be provided on a user interface of a screen 260. For some embodiments, the vehicle 250 may also change operating parameters to slow down and increase the distance d between the vehicles. For some embodiments, a user of the rear vehicle may be given the recommendation and an option to slow down the rear vehicle.

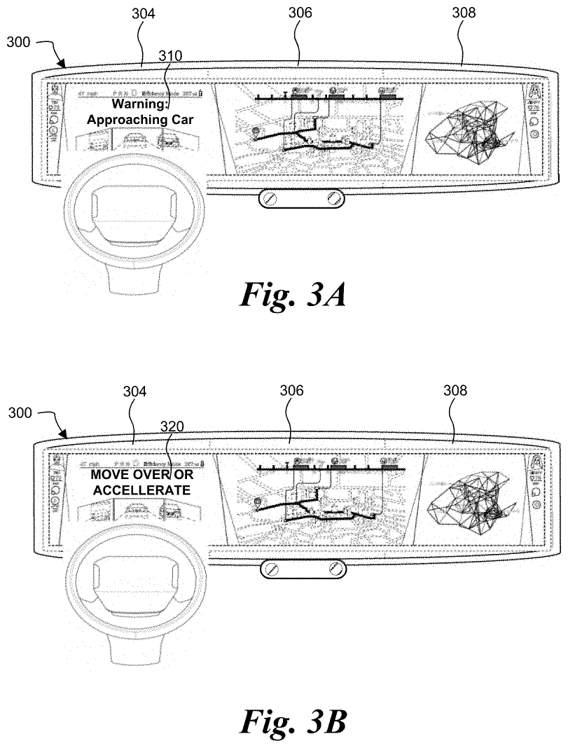

FIG. 3A illustrates a vehicle dashboard 300 which includes a plurality of displays. In the illustrated embodiment dashboard 300 includes a single display which can be configured to display different things in three software-configurable display regions 304, 306, and 308, but in other embodiments dashboard 300 can have a different number of display regions than shown and in still other embodiments regions 304, 306, and 308 can be physically separate displays. The display regions 304, 306 and 308 may be controlled by a control/GUI generator such as control/GUI generator 312 as described with reference to FIG. 1.

As shown in FIG. 3A, the display region 304 includes a warning indicating that a car is approaching. This can be provided to the driver as an indication of potential danger. In response, the driver can adjust their braking speed, increase their velocity, or change lanes.

FIG. 3B illustrates another embodiment of a vehicle dashboard 300 which includes a plurality of displays. In the illustrated embodiment dashboard 300 includes a single display which can be configured to display different things in three software-configurable display regions 304, 306, and 308, but in other embodiments dashboard 300 can have a different number of display regions than shown and in still other embodiments regions 304, 306, and 308 can be physically separate displays. The display regions 304, 306 and 308 may be controlled by a control/GUI generator such as control/GUI generator 312 as described with reference to FIG. 1. As shown in FIG. 3B, the display region 304 includes a warning 320 indicating that a car is approaching and recommending options to improve safety. This can be provided to the driver as an indication of potential danger. In response, the driver can adjust their braking speed, increase their velocity, or change lanes.

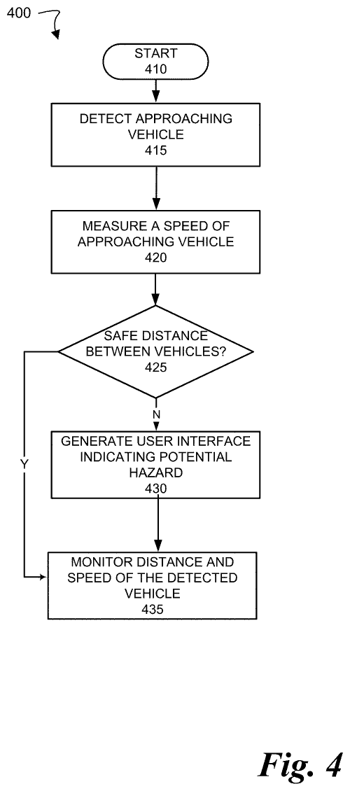

FIG. 4 is a flow chart 400 illustrating example operations of a tailgating alert system. For some embodiments, operations discussed with reference to flow char 400 may be carried out by tailgating alert system 150 or computer 112 as discussed with reference to FIG. 1. Beginning in block 415, a tailgating alert system may detect an approaching vehicle. The tailgating alert system may detect the approaching vehicle based on sensor readings from outputs of radars, sonars, imaging devices, thermal imaging devices, or the like. For some embodiments, the sensor outputs may include an indication of distance of the detected vehicle, speed of the detected vehicle, size of the detected vehicle, or other information about the detected vehicle.

Based on the output of one or more sensors, in block 420, the tailgating alert system can determine a speed of the approaching vehicle. The speed of the vehicle approaching from the rear can indicate whether it is moving faster or slower than the vehicle that includes the tailgating alert system. Moving to block 425, the tailgating alert system can determine if there is a safe distance between the vehicles. As discussed above, this can include general speed and distance measurements or additional information indicating the size of the approaching vehicle, the type of approaching vehicle, road conditions, or additional information that changes assumptions used to generate a detection of a safe driving distance. Based on a generated threshold of safe driving distances, the tailgating alert system can determine based on a measured distance if the following vehicle is to close.

In response to a determination of an unsafe driving distance, in block 430, a tailgating alert system can generate an indication that the following vehicle is too close in response to the vehicle being less than a threshold distance away. For some embodiments, the warning is provided to indicate the potential hazard, while in other embodiments, the interface provides an indication of potential options to improve safety. For example, the tailgating alert system may provide interfaces similar to those described with reference to FIG. 3A or 3B. If the distance between the cars is safe according to a tailgating alert system, the system can continue in block 435 to monitor the distance of the detected vehicle. Thus, if conditions change, distance changes, or other parameters change, the tailgating alert system can generate an alert indicating the new unsafe conditions.

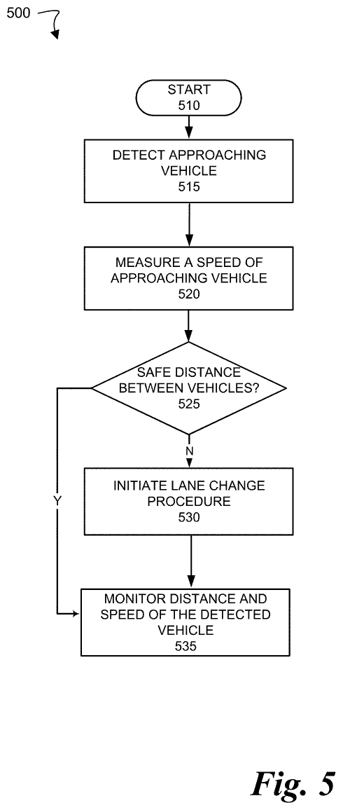

FIG. 5 is a flow chart 500 illustrating example operations of a tailgating alert system. For some embodiments, operations discussed with reference to flow char 500 may be carried out by tailgating alert system 150, computer 112, or vehicle operation systems 114 as discussed with reference to FIG. 1. Beginning in block 515, a tailgating alert system may detect an approaching vehicle. The tailgating alert system may detect the approaching vehicle based on sensor readings from outputs of radars, sonars, imaging devices, thermal imaging devices, or the like. For some embodiments, the sensor outputs may include an indication of distance of the detected vehicle, speed of the detected vehicle, size of the detected vehicle, or other information about the detected vehicle.

Based on the output of the one or more sensors, in block 520, the tailgating alert system can determine a speed of the approaching vehicle. The speed of the vehicle approaching from the rear can indicate whether it is moving faster or slower than the vehicle that includes the tailgating alert system. For some embodiments the speed of the vehicle is provided as an output of a sensor (e.g., radar) while in other embodiments the speed is determined based on changing distances of objects detected by the sensors.

Moving to block 525, the tailgating alert system can determine if there is a safe distance between the vehicles. As discussed above, this can include general speed and distance measurements or additional information indicating the size of the approaching vehicle, the type of approaching vehicle, road conditions, or additional information that changes assumptions used to generate a detection of a safe driving distance. Based on a generated threshold of safe driving distances, the tailgating alert system can determine based on a measured distance if the following vehicle is to close.

In response to a determination of an unsafe driving distance, in block 530, a tailgating alert system can generate an indication that the following vehicle is too close in response to the vehicle being less than a threshold distance away. This indication can be used to initiate procedures to change parameters of vehicle operations. For example, the tailgating alert system can initiate operations to accelerate, change lanes, or otherwise improve safety. For some embodiments, a warning can also be provided to indicate the potential hazard, while in other embodiments, the interface provides an indication of potential options to improve safety. For example, the tailgating alert system may provide interfaces similar to those described with reference to FIG. 3A or 3B. If the distance between the cars is safe according to a tailgating alert system, the system can continue in block 535 to monitor the distance of the detected vehicle. Thus, if conditions change, distance changes, or other parameters change, the tailgating alert system can generate an alert indicating the new unsafe conditions.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A system comprising:
a memory device; and
a computer operatively coupled to the memory device, wherein the processing device is to:
detect, from a first vehicle, a second vehicle to the rear of the first vehicle;
determine a threshold value of an unsafe distance between the first vehicle and the second vehicle;
determine, based on the speed of the second vehicle, that the distance between the first vehicle and the second vehicle satisfies the threshold value; and
generate an input to change the operation of a vehicle operation system to improve safety of the first vehicle.

2. The system of claim 1, wherein the computer is further to detect the speed of the second vehicle with a frequency modulated continuous wave radar.

3. The system of claim 1, wherein to determine the speed of the second vehicle the computer is further to:
determine a first distance of the second vehicle at a first time;
determine a second distance of the second vehicle at a second time; and
determine the speed of the second vehicle based on a difference between the first distance and the second distance.

4. The system of claim 1, wherein the computer is further to present, on a user interface of the first vehicle, a warning indicating that there is an unsafe distance between the first vehicle and the second vehicle.

5. The system of claim 1, wherein the computer is further to update the determination that there is an unsafe distance between the first vehicle and the second vehicle based on road conditions.

6. The system of claim 1, wherein the computer is further to display on a rear facing display of the first vehicle an indication that there is an unsafe distance between the first vehicle and the second vehicle.

7. The system of claim 1, wherein the computer is further to generate a message to the second vehicle indicating that it is following the first car too closely.

8. A non-transitory computer-readable medium having instructions stored thereon that, when executed by a computer, cause the processing device to:
detect, from a first vehicle, a second vehicle to the rear of the first vehicle;
determine a speed of the second vehicle;
determine, based on the speed of the second vehicle, that there is an unsafe distance between the first vehicle and the second vehicle; and
generate an input to change the operation of a vehicle operation system to improve safety of the first vehicle.

9. The non-transitory computer-readable medium of claim 8, wherein the computer is further to determine speed of the second vehicle with a frequency modulated continuous wave radar.

10. The non-transitory computer-readable medium of claim 8, wherein to determine the first distance of the second vehicle, the computer is further to:
determine a first distance of the second vehicle at a first time;
determine a second distance of the second vehicle at a second time; and
determine the speed of the second vehicle based on a difference between the first distance and the second distance.

11. The non-transitory computer-readable medium of claim 8, wherein the computer is further to update an operation of the vehicle.

12. The non-transitory computer-readable medium of claim 8, wherein the computer is further to generate a message to transmit to the second vehicle indicating that it is following too closely.

13. A vehicle comprising:
one or more sensors to detect an environment surrounding the vehicle
a memory device; and
a computer operatively coupled to the memory device and the one or more sensors, wherein the processing device is to:
identify a trailing vehicle to the rear of the vehicle;
determine a threshold value of an unsafe distance between the vehicle and the trailing vehicle;
determine, based on the speed of the trailing vehicle, that the distance between the vehicle and the trailing vehicle satisfies the threshold value; and
generate an input to change the operation of the vehicle to improve safety of the first vehicle.

14. The vehicle of claim 13, wherein the one or more sensors further comprise a frequency modulated continuous wave radar to detect the speed of the trailing vehicle.

15. The vehicle of claim 13, wherein to determine the speed of the second vehicle the computer is further to:
determine a first distance of the second vehicle at a first time;
determine a second distance of the second vehicle at a second time; and
determine the speed of the second vehicle based on a difference between the first distance and the second distance.

16. The vehicle of claim 13, wherein the vehicle further comprises a user interface and the computer is further to present, on the user interface, a warning indicating that there is an unsafe distance between the vehicle and the trailing vehicle.

17. The vehicle of claim 13, wherein the computer is further to update the determination that there is an unsafe distance between the vehicle and the trailing vehicle based on road conditions.

18. The vehicle of claim 13, further comprising a rear facing display, wherein the computer is further to display on the rear facing display an indication that there is an unsafe distance between the vehicle and the trailing vehicle.

19. The vehicle of claim 13, wherein the computer is further to transmit a message to the trailing vehicle indicating that it is following the vehicle too closely.

20. A method comprising:
detecting, from a first vehicle, a second vehicle to the rear of the first vehicle;
determining a speed of the second vehicle;
determining, based on the speed of the second vehicle, that there is an unsafe distance between the first vehicle and the second vehicle; and
generating an input to update the operation of a vehicle operation system to maneuver the vehicle into a safer condition.

21. The method of claim 20, further comprising detecting the speed of the second vehicle with a frequency modulated continuous wave radar.

22. The method of claim 20, wherein determining the speed of the second vehicle comprises:
determining a first distance of the second vehicle at a first time;
determining a second distance of the second vehicle at a second time; and
determining the speed of the second vehicle based on a difference between the first distance and the second distance.

23. The method of claim 20, further comprising presenting, on a user interface of the first vehicle, a warning indicating that there is an unsafe distance between the first vehicle and the second vehicle

24. The method of claim 20, further comprising changing the determination that there is an unsafe distance between the first vehicle and the second vehicle based on road conditions.

25. The method of claim 20, further comprising displaying an indication that there is an unsafe driving distance on a rear facing display of the first vehicle in response to determining that there is an unsafe distance between the first vehicle and the second vehicle.

26. The method of claim 20, further comprising transmitting a message to the second vehicle indicating that it is following the first car too closely.
